(19) United States
(12) Patent Application Publication
(10) Pub. No.: US 2011/0193429 A1
(43) Pub. Date: Aug. 11, 2011

(54) COIN-TYPE VIBRATION MOTOR

(76) Inventor: SangEui Lee, Jinju-si, Gyeongsangnam-do (KR)

(21) Appl. No.: 13/120,481

(22) PCT Filed: Sep. 23, 2009
(86) PCT No.: PCT/KR09/05413

§ 371 Date: Mar. 23, 2011

(30) Foreign Application Priority Data
Sep. 24, 2008 (KR) 10-2008-0093770

(51) Int. Cl. H02K 1/04

(52) U.S. Cl. 310/43

(57) ABSTRACT

Disclosed is an improved coin-type vibration motor, which has a larger vibration force and is not easily broken even by a strong impact. A permanent magnet in which an N-pole and an S-pole are alternately arranged is disposed centering around a rotation shaft fitted in a center of an inside of the case, and a brush having an upwardly and slantingly extending shape is connected with a flexible printed circuit disposed between the permanent magnet and a bottom surface of the case. A rotor spaced apart from an upper part of the permanent magnet and rotatably supported by the rotation shaft according to that a rotation center is fitted in the rotation shaft. A wiring board including a commutator is assembled with a lower part of a bearing, and plural coils symmetrically spaced apart from each other centering around the rotation shaft and a vibrator of high specific gravity are sequentially layered on the wiring board. The wiring board, the plural coils, and the vibrator are integrally assembled by a resin injection molding body, to form the rotor. The vibrator has a shape of a flat plate shaped like an arc or a fan extending from a circumference of the bearing to a circumference of the rotor. Having a shape eccentric from the rotation shaft due to its arc or a fan shaped coin type, the rotor eccentrically rotates to generate the increased vibration force by the eccentricity.

### BACKGROUND OF THE INVENTION

1. Field of the Invention

The present invention relates to a vibration motor, and more particularly to a coin-type vibration motor, which is installed in a portable electronic device, such as a mobile phone and a pager, so that it generates vibration as necessary.

2. Description of the Prior Art

A mobile communication terminal, such as a mobile phone and a pager adopts a vibration motor serving as a means for informing a user of the signal reception. Most of the vibration motors were initially adopted a bar-type cylindrical shape, but have recently adopted a coin-type shape.

FIGS. 1 and 2 illustrate a representative basic structure of a conventional coin-type vibration motor. FIG. 1 is a perspective view illustrating an assembling state of the conventional coin-type vibration motor and FIG. 2 is an exploded perspective view illustrating the vibration motor.

As illustrated in FIGS. 1 and 2, the vibration motor includes a metallic upper case 10, a metallic lower case 12, and a flexible printed circuit 16. The upper case 10 and the lower case 1 are forcibly assembled with each other to form an empty inner space. A part of the flexible printed circuit 16 extends outward from the cases 10 and 12. A vertical rotation shaft 18 is fitted in to the center of the inside of the cases 10 and 12, so that the rotation shaft 18 supports the cases 10 and 12. The flexible printed circuit 16 for transferring a signal is seated on a bottom of the lower case 12. A permanent magnet 14 shaped like a ring is arranged centering around the rotation shaft 18 on the flexible printed circuit 16. A rotor 20 is positioned on the permanent magnet 14 while being rotatably supported with respect to the rotation shaft 18. The rotor 20 includes a body 24 shaped like an approximately semicircular plate, a bearing 28 integrally formed with the body 24, coils 22, a vibrator 26, and a printed circuit (not shown). The rotation shaft 18 is inserted in the bearing 28, and two or more coils 22 are symmetrically disposed in left and right sides of the body 24 based on the center of the rotation shaft 18. Further, the vibrator 26 is positioned adjacently to an edge of the body 24 at a position between the coils 22. The vibrator 26 is made of a material of high specific gravity so as to obtain a strong vibration force.

When a direction of the electric current flowing on the coil 22 is alternately changed, a direction of a magnetic pole representing in the coil 22 is alternately changed according to the change of the electric current direction. The change of the magnetic pole interconnects with a magnetic pole of the permanent magnet 14 and generates a force which makes the coils 22 rotate in one direction. Therefore, the rotor 20 integrally formed with the coils 22 rotates with respect to the rotation shaft 18.

A method of manufacturing the rotor 20 of the conventional coin-type vibration motor is as follows. First, a dual-sided printed wiring board having a shape of an approximate semicircle and including a commutator and circuit patterns is prepared. The dual-sided printed wiring board is manufactured by a method in which the commutator and the circuit patterns are formed on the dual-sided printed wiring board by an etching process, the patterns on both sides of the printed wiring board are connected through a plating of a through-hole, and nickel (Ni) and gold (Au) are plated again on the commutator and the circuit patterns. The two or more coils 22 are laid on the printed wiring board manufactured by the above method, the vibrator 26 having high specific gravity is disposed between the coils 22, the bearing 26 is disposed at the center of a virtual circle of the rotor 20, and then the coils 22, the vibrator 26, the bearing 28, and the printed wiring board are integrally formed by a resin injection molding. An obtained resin solid product becomes the body 24 shown in FIG. 2. It is preferred that the vibrator 26 is subjected to a plating process and then installed so as to prevent the corrosion of the vibrator 26.

The vibrator 26 provides the rotor 20 with the eccentric force and is made of a metal of high specific gravity. In this respect, the center of gravity of the rotor 20 is concentrated at a specific portion due to the vibrator 26. According to the structural characteristic of the rotor 20, when a strong force is applied to the vibrator 26, the vibrator 26 is separated from the rotor 20. Further, the central bearing 28 is also separated from the body 24 of the resin injection molding body. Therefore, a size of the vibrator 26 was controlled to be a size equal to or smaller than a predetermined size (in order that a force equal to or larger than a predetermined size is not applied to the vibrator 26), so that there was a limitation in the increase of the vibration quantity.

Further, the resin material is not properly injected to central holes of the coils 22 in the resin injection molding, so that a vacant space may be created, in which the vacant space may cause the deformation of the coil by the exterior pressure in the injection molding. In this case, if such coils are used for a long time, the coils may develop a disconnection error, which results in the weakening of the durability of the motor.

### SUMMARY OF THE INVENTION

Accordingly, the present invention has been made to solve the above-mentioned problems occurring in the prior art, and the present invention provides a vibration motor capable of generating a stronger vibration force without an increase of the size in comparison with the conventional vibration motor.

Further, the present invention provides a vibration motor designed so that a rotor is not easily broken even by the strong impact force according to the increase of the size of a vibrator.

Furthermore, the present invention provides a vibration motor designed so that it is possible to prevent the coil from being deformed by the resin injection molding pressure and from being disconnected by the deformation of the coil.

As the mobile phone becomes compact, the components installed therewithin must have a small size, which is also applied to the vibration motor. In order to make the vibration motor have the small size, it is inevitable to reduce the size of the rotor. According to the existing scheme in which the vibrator is disposed between the plural coils, it cannot help but reducing the size of the vibrator. However, such a structure cannot maintain the desired weight of the vibrator, so that it is impossible to obtain the vibration of a desired quantity. In this respect, it is necessary to improve the structure of the rotor for the increase of the specific gravity of the vibrator based on the entire size of the rotor.

In accordance with an aspect of the present invention, there is provided a coin-type vibration motor, including: an upper case and a lower case, which are engaged with each other to form a circular space for rotation in an inside of the cases; a rotation shaft vertically fitted in center parts of the upper case and the lower case opposed to each other; a rotor rotatably supported by the rotation shaft according to that a rotation center of the rotor is positioned in the rotation shaft, the rotor being integrally assembled with plural coils and a vibrator by a resin injection molding body, the rotor having an eccentric structure and having a shape of an arc or a fan, in which the plural coils generating magnetic fields and the vibrator of high specific gravity are sequentially layered on a wiring board including a commutator; a permanent magnet spaced apart from the rotor while maintaining a uniform clearance and fixed to a bottom surface of the lower case under the rotor, the permanent magnet having the N-pole and the S-pole alternately disposed around a ring-type circumference; a flexible printed circuit installed between the permanent magnet and the bottom surface of the lower case and connected to an external power source; and a brush, which is extended so as to include one end connected to the flexible printed circuit and another end in contact with the commutator, the brush transferring electric power transferred through the flexible printed circuit from the external power source to the coils of the rotor via the commutator, in which when the electric power is supplied to the coils of the rotor, the rotor eccentrically rotates with respect to the rotation shaft.

In the coin-type vibration motor, it is preferred that each of the plural coils is an hollow-core coil, the resin injection molding body is filled in the hollow cores of the plural coils, and the vibrator is layered on upper surfaces of the coils while covering one half or more of the upper surfaces of the plural coils, but leaving a part of the hollow cores in an open state in order to inject the resin injection molding body into the hollow core of each of the plural coils.

According to an exemplary embodiment of the rotor, the rotor further includes a bearing, which is positioned at the rotation center of the rotor and shaped like a cylinder having an open hole in a direction of the rotation shaft in an inside of the bearing, so that the bearing is fitted in and supported by the rotation shaft. Further, the wiring board has an assembling hole, in which the bearing can be inserted, at a position facing the rotation center on a printed circuit board having an arc shape or a fan shape, so that the wiring board is fitted in a lower part of the bearing through the assembling hole to form a lower part of the rotor; multiple commutator patterns around an outer circumferential surface of the bearing; and multiple wire patterns connected to the multiple commutator patterns, respectively. The rotor is shaped like a coin having an arc shape or a fan shape and adopts a circle center as the rotation center.

According to the vibration motor, it is principally characterized in that the vibrator is disposed on the upper surfaces of the coils in order to make a size of the vibrator larger and thus increase a weight of the rotor.

It is preferred that the vibrator has a stepped portion (b) along an edge circumference of the upper surface of the vibrator in order to improve an assembling force between the vibrator and the resin injection molding body of the rotor.

It is preferred that the vibrator has a thickness L1 equal to or smaller than an entire thickness L2 of the plural coils.

Then, a further consideration is required in addition to the change of the position of the vibrator to the upper surfaces of the coils. In order to increase a size of the vibrator, it is necessary to increase either an area of a plane surface of the vibrator or a thickness of the vibrator. In considering the demand for a compact vibration motor, a method of the disposal of the vibrator on the upper surfaces of the coils of the rotor has a limitation in the increase of the thickness of the vibrator, but has some leeway to increase the area of the plane surface of the vibrator. Taking that fact into consideration, it is preferable to make the vibrator be thin and have a plane surface as wide as possible. Therefore, as viewed from above in a vertical direction, the vibrator is overlapped with the plural coils, and it is preferred that an angle of a circular arc of the vibrator covers at least one half of the upper surfaces of the coils within a range of 180° based on the rotation center. Through such a structure, it is possible to generate further higher vibration force. Further, it is preferred to leave a part of the air core be opened without covering the entirety of the hollow cores of the coils, in order to inject the resin injection molding body into the hollow cores. In resin injection molding for the integration of the elements of the rotor, the resin injection molding body is injected into the hollow cores of the coils through the openings, as well as the outside of the coils. For example, it is preferred that the vibrator is a flat plate having an arc or fan shape that can cover almost all of an arcuate or fan-shaped region of the rotor, which is enclosed by a boundary line and a circular arc connected with the boundary line and is capable of surrounding a partial portion around the bearing while leaving a part of the hollow cores of the hollow-core coils uncovered.

The vibrator was conventionally manufactured by sintering tungsten powder of high specific gravity at a high temperature. However, the vibrator manufactured by the conventional method has poor planarization, so that there was a technical difficulty in installing the vibrator on the upper surfaces of the coils. In order to solve such a problem, it is preferred to add nickel of an appropriate quantity to the tungsten powder of high specific gravity. It is preferable to add 3 to 6% of nickel with respect to the entire weight of the vibrator. The vibrator is manufactured through sintering a mixture of the tungsten powder and the nickel. The vibrator including the nickel comes to have a surface property that corrosion does not occur if a separate post-processing of a plating is not performed to the vibrator.

It is preferred that the resin injection molding body at an opposite side (a rear side of the coils) of a position of the vibrator based on the rotation shaft has a height h1 equal to or lower than a height h2 of the coil.

It is preferred that the bearing has fastening parts shaped like a groove at an outer circumferential surface of the bearing so as to improve an assembling force in assembling with the resin injection molding body of the rotor.

It is preferred that a pattern resistor for preventing the generation of a flame between the brush and the commutator is further installed on the wiring board in a form of being connected to the wire pattern.

Prior to integrally forming the elements of the rotor into a single body by the resin injection molding, the vibrator is adhered to the upper surfaces of the coils by using the adhesive. This is a measure for preventing the vibrator from moving caused by the injection molding pressure during the resin injection molding. It is preferable to use an anaerobic UV adhesive as the adhesive.

In accordance with another aspect of the present invention, there is provided a permanent magnet having an N-pole and an S-pole centering around a rotation shaft fitted in a center of an inside of a case; a flexible printed circuit disposed between the permanent magnet and a bottom surface of the case; a brush connected with the flexible printed circuit, the brush having an upwardly and slantingly extending shape; and a rotor spaced apart from an upper part of the permanent magnet and rotatably supported by the rotation shaft according to that a rotation center is fitted in the rotation shaft, wherein the rotor includes plural coils and a vibrator, in which the plural coils are disposed on a wiring board including a commutator and is electrically connected with the wiring board, and the vibrator of high specific gravity is layered on the plural coils, and elements of the rotor are integrally assembled with each other by a resin injection molding body, to have a shape of a coin having an arc or fan shape and be eccentric from the rotation shaft, and when the rotor rotates by an interaction between magnetic fields generated by the plural coils through an electric current supplied through the flexible printed circuit and the brush and the magnetic poles of the permanent magnet, the rotor eccentrically rotates to generate vibration.

In the coin-type vibration motor, it is preferred that the rotor further includes a bearing, which is positioned at the rotation center of the rotor and is shaped like a cylinder having an open hole in a direction of the rotation shaft in an inside of the rotor, so that the bearing is fitted in and supported by the rotation shaft.

According to an embodiment of the rotor, the rotor includes: a bearing positioned at the rotation center of the rotor and fitted in and supported by the rotation shaft; a wiring board including an assembling hole, in which the bearing is inserted, at a rotation center of a circuit board of a circuit board disposed as a lower part of the rotor, and multiple commutator patterns and wire patterns connected to the plural commutator patterns, respectively, around an outer circumferential surface of the bearing; plural coils symmetrically spaced apart from each other centering around the rotation shaft in a predetermined distance on the wiring board and connected to the wire patterns of the commutator, the plural coils generating magnetic fields when an electric current flows therethrough; and a vibrator made of a material of high specific gravity, shaped like an arc or a fan extending from a circumference of the bearing to a vicinity of a circumference of the rotor, and layered on upper surfaces of the coils; and a body formed with a resin injection molding body which is injection molded between entire elements of the rotor to make the elements be integrally assembled with each other, and makes an entire shape of the rotor have a coin-shape like an arc or a fan having a size larger than a size of the wiring board.

It is preferred that the bearing has fastening parts shaped like a groove at an outer circumferential surface of the bearing so as to improve an assembling force in assembling with the resin injection molding body of the rotor.

It is preferred that the vibrator is a flat plate having an arc or fan shape that can cover almost all of an arcuate or fan shaped region of the rotor, which is enclosed by a boundary line and a circular arc connected with the boundary line and is capable of surrounding a partial portion around the bearing while leaving a part of the hollow cores of the hollow-core coils uncovered.

The improved vibration motor according to the present invention has a structure in which the rotor includes the vibrator disposed on the upper surfaces of the coils, so that it is possible to install the large sized vibrator in comparison with the conventional vibration motor and obtain a larger eccentric force of the rotor, and thus obtain a higher vibration force. Further, the present invention has little limitation in the decrease or increase of the thickness of the vibrator. When the thickness of the vibrator is changed, it is possible to change the load of the vibrator, so that it is possible to easily decrease or increase the vibration quantity.

Further, the weight of the vibration is evenly disposed on the entire surface of the rotor, so that it is possible to prevent the vibrator from being separated by the strong impact.

Even in this structure, it is possible to integrally form the entire elements of the rotor with the resin, so that the high assembling force between the elements can be achieved. Therefore, the vibration motor of the present invention has the structure that is not easily separated or broken by the strong impact.

Further, according to the vibration motor of the present invention, the upper surfaces of the coils of the rotor are fixed to and supported by the wiring board and the lower surfaces of the coils of the rotor are fixed to and supported by the vibrator, so that the coils are not easily deformed by the outside impact.

Furthermore, the vibration motor of the present invention has a structure designed so that the resin injection molding can be injected to the hollow cores of the coils, as well as the outside of the coils, in the resin injection molding, so that it is possible to prevent the coils from being deformed by the resin injection molding pressure, thereby preventing the disconnection error of the coils.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a conventional coin-type vibration motor;

FIG. 2 is an exploded perspective view illustrating a conventional coin-type vibration motor;

FIG. 3 is an exploded perspective view illustrating a coin-type vibration motor according to an exemplary embodiment of the present invention;

FIG. 4 is a cross-sectional view illustrating an inside of a coin-type vibration motor according to an exemplary embodiment of the present invention;

FIG. 5 is a plan view illustrating a rotor of a coin-type vibration motor according to an exemplary embodiment of the present invention;

FIG. 6 is a cross-sectional view taken along line A-A of FIG. 5;

FIG. 7 is a bottom view illustrating the rotor of FIG. 5;

FIGS. 8A and 8B are views illustrating the deformation of coils by a resin injection pressure; and

FIGS. 9 to 12 are views illustrating a process of a resin injection molding for a rotor.

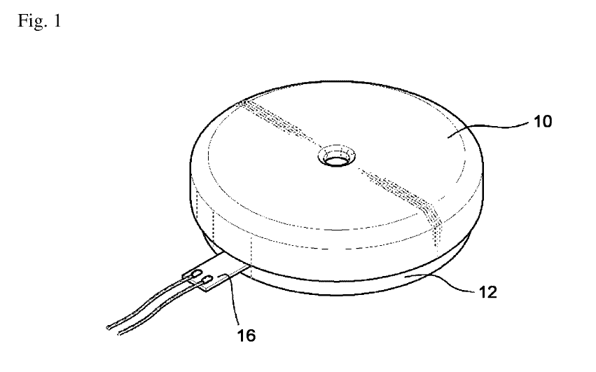

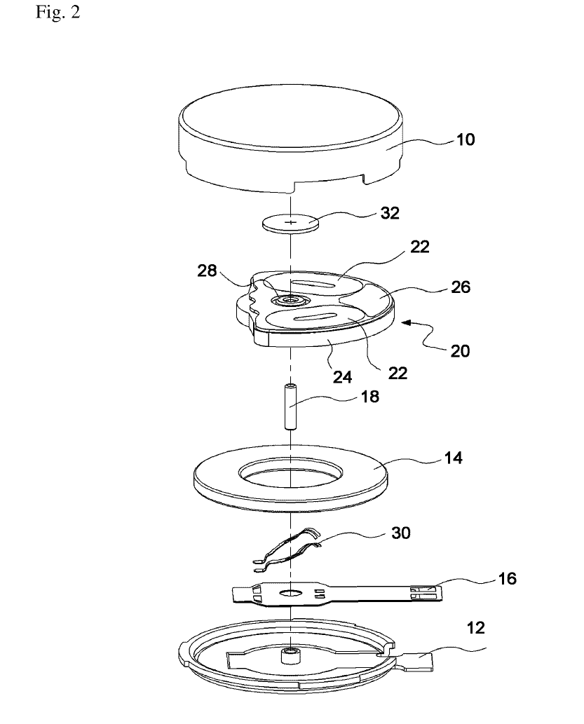

### DETAILED DESCRIPTION OF THE EXEMPLARY EMBODIMENTS

Hereinafter, an exemplary embodiment of the present invention will be described with reference to the accompanying drawings in detail.

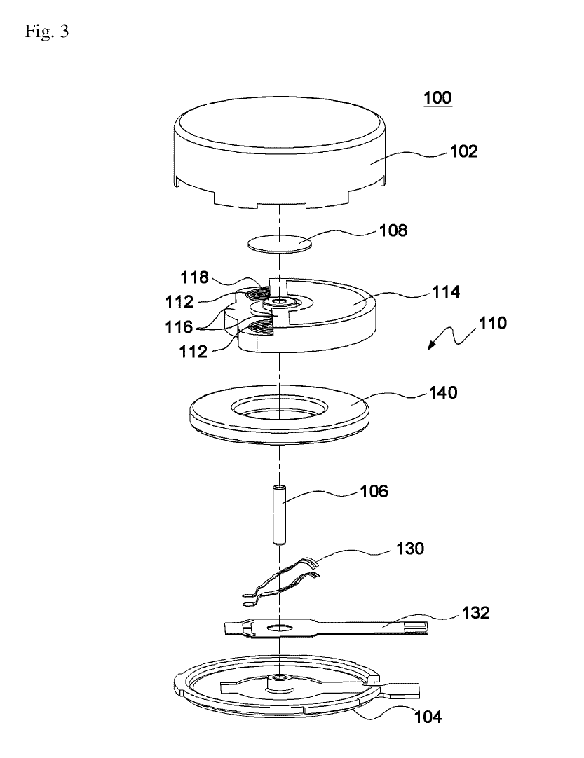

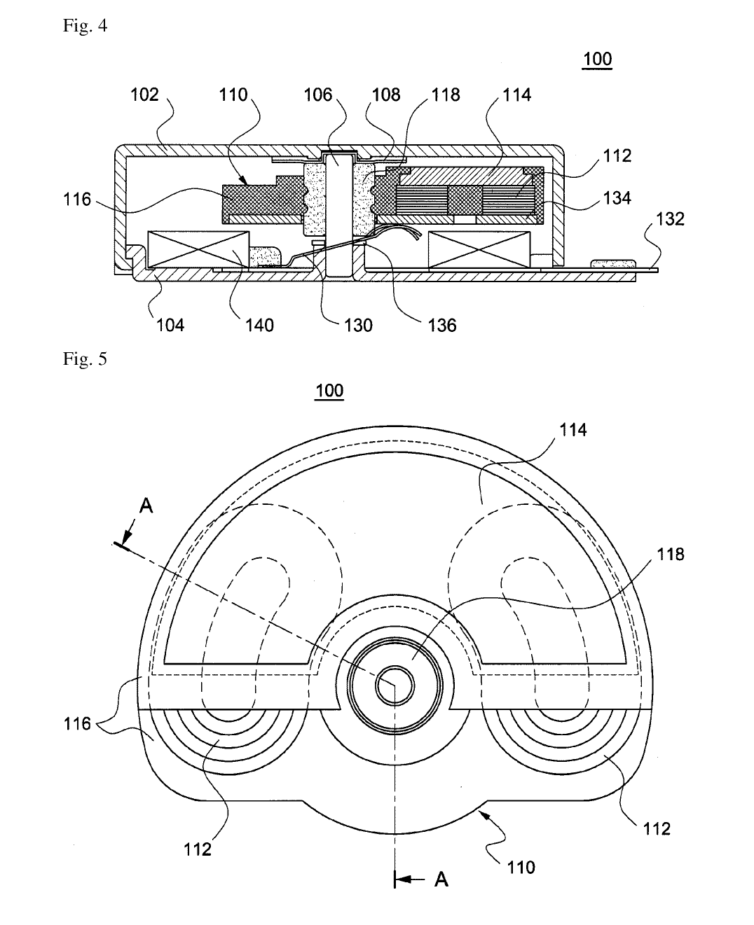

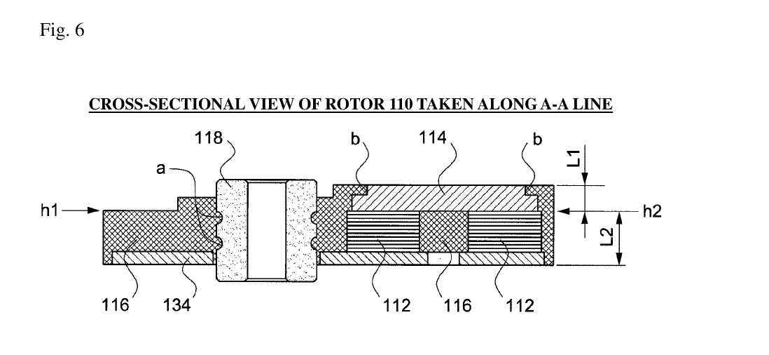

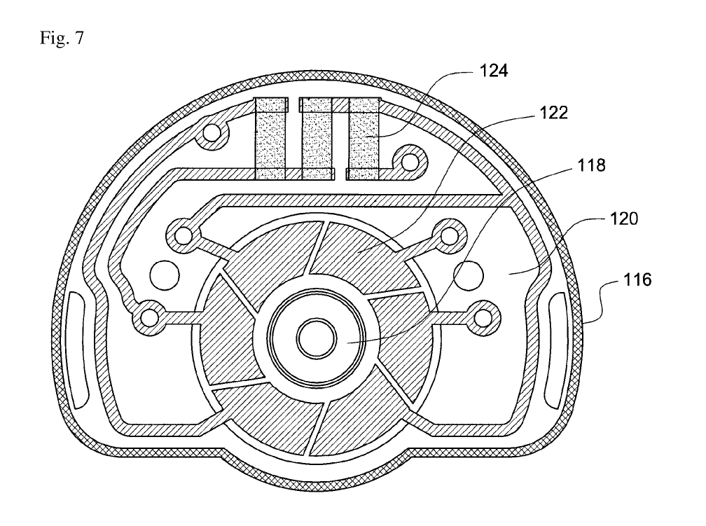

FIG. 3 is an exploded perspective view illustrating a coin-type vibration motor 100 of the present invention, FIG. 4 is a cross-sectional view illustrating an inside of the coin-type vibration motor 100 of the present invention, FIG. 5 is a plan view illustrating a rotor 110 of the coin-type vibration motor 100 of the present invention, FIG. 6 is a cross-sectional view taken along line A-A of FIG. 5, and FIG. 7 is a bottom view illustrating the rotor 110 of FIG. 5.

As illustrated in FIGS. 3 and 4, the coin-type vibration motor 100 includes an upper case 102 having a cup shape and a lower case 104 shaped like a flat plate to close an entrance of the upper case 102. The upper case 102 and the lower case 104 are made of a metallic material to be appropriate for the forcible assembling. Each of the upper case 102 and the lower case 104 has a groove and a hole at the center of each of the case 102 and the case 104. A rotation shaft 106 is vertically inserted in and fitted in the grooves and the holes.

A rotation center of the rotor 110 is positioned in the rotation shaft 106, so that the rotor 110 is rotatably supported with respect to the rotation shaft 106. The rotor 110 is shaped like an arc including a center of a circle (in a shape of ‘D’) or a fan. For example, when the rotor 110 is formed in the arcuate or fan shape, it is preferred that the area of the rotor 110 is larger than that of a semicircle. When it is assumed that the rotor 110 has a circular shape, the rotation center of the rotor 110 is at the same position as the center of the circle, so that the rotor 110 is eccentric from the rotation shaft.

The rotor 110 includes a plurality of coils 112, a vibrator 114, a body formed with a resin injection molding body 116, and a bearing 118 having a cylindrical shape, a wiring board 134, a commutator 122, and a pattern resistor 124. The wiring board 134 is a printed circuit board having an arc or a fan shape identical to the shape of the plane of the rotor 110 and includes an assembling hole, in which the bearing 118 is inserted, at the position of the rotation center (the center of the circle of the arcuate or fan shape). The wiring board 134 is fitted in a lower part of the bearing 118 through the assembling hole, to form a lower surface of the rotor 110. The wiring board 134 has multiple exposed commutator patterns and multiple exposed wire patterns, which are connected to each other, respectively, and are disposed around the outer circumferential surface of the bearing 118. The bearing 118 is shaped like a cylinder of which an inside extends through in the direction of the rotation shaft, and the rotor 110 has a structure including a shaft-directional open hole at the rotation center of the rotor 110. Therefore, the rotation shaft 106 extends through and is assembled with the shaft-directional open hole of the bearing 118.

Further, the rotor 110 includes a wiring board 134 inserted in the lower part of the bearing 118 and two coils 112, each of which has a distorted elliptical shape and which are symmetrically disposed to each other centering around the bearing 118 while being spaced apart from each other in a predetermined distance on the wiring board 134. Further, the vibrator 114 that is a core element of the structural characteristic of the present invention is positioned on upper surfaces of the two coils 112. All the constructional elements, i.e. the coils 112, the vibrator 114, the bearing 118, and the wiring board 134, of the rotor 110 are integrally formed by the resin injection molding body 116, to have an entire shape having the arcuate shape similar with the ‘D’ shape or the fan-shape coin as previously discussed.

The vibrator 114 functions as an eccentric means of the rotor 110, so that it is generally made of a weight body of a high specific gravity material. The vibrator 114 of the present invention is fixed in a form of covering the upper surfaces of the coils 112, so that it is necessary to specially consider the material and the shape of the vibrator 114. It is preferred that the vibrator 114 is made of a material, such as a non-magnetic metal or a non-magnetic weight body, so that it minimizes the effect in magnetic fields generated in the coils 112. Further, it is preferred that the vibrator 114 is formed in a shape of a thin plate so as to minimize the thickness increase of the rotor 110 according to a layered structure, but the vibrator 114 has a wide area so as to sufficiently provide the eccentric force required.

In this respect, the vibrator 114 of the present invention is manufactured through adding a predetermined amount of nickel to tungsten powder of high specific gravity and sintering the mixture at a high temperature. The addition of the nickel achieves the satisfactory planarization of the vibrator 114, as well as the corrosion resistance of the surface, so that it is advantageously possible to install the vibrator 114 on the upper surfaces of the coils 112. In manufacturing the vibrator 114, there was a problem in that the vibrator 114 was bent in a case where the vibrator 114 having the thin thickness and the wide area was manufactured. In order to solve the above problem, the inventor of the present invention added a correction process in which the vibrator 114 obtained after the sintering process is pressed by a press. As a result, it was possible to manufacture the vibrator 114 having no distortion and a thin thickness of a minimum 0.25 mm. Further, it is preferred to form the vibrator 114 in a shape of an arc or a fan in order to manufacture the vibrator 114 having the wide area. That is, as illustrated in FIG. 5 or FIGS. 9 to 12, it is preferred to make the vibrator 114 have an arcuate shape or a fan shape that can cover an arcuate or fan shaped region of the rotor 110, which is enclosed by a boundary line and a circular arc connected with the boundary line and is capable of surrounding a partial portion around the bearing 118 that is the rotation center while leaving a part of the hollow cores 112a of the hollow coils uncovered.

The coils 112 are the hollow coils. Even in the event of the installation of three or more coils, the coils are uniformly disposed on the rotor 110, thereby achieving the high efficiency. Especially, a soldered part of the coil 112 is vulnerable to the disconnection, so that the soldered part is coated with an UV bond and then dried under ultraviolet light.

In describing a method for installing the vibrator 114 on the upper surfaces of the coils 112, first, the vibrator 114 is fixed to the upper surfaces of the coils 112 by using an adhesive before the performance of the resin injection molding. The fixing using the adhesive prevents the vibrator 114 from moving due to the injection molding pressure in the resin injection molding. Therefore, it is possible to make the weight center of the rotor be uniform in the mass production, thereby also uniformly maintaining the vibration quantity. Further, the coils 112 are adhered to the vibrator 114, so that it is possible to prevent the deformation of the coils even in the high injection molding pressure, thereby preventing the disconnection error of the coils 112. The adhesive, which is used for fixing the lower surface of the vibrator 114 and the upper surfaces of the coils 112, preferably is an anaerobic UV adhesive generating no gas in drying and gluing in a place where air does not pass through.

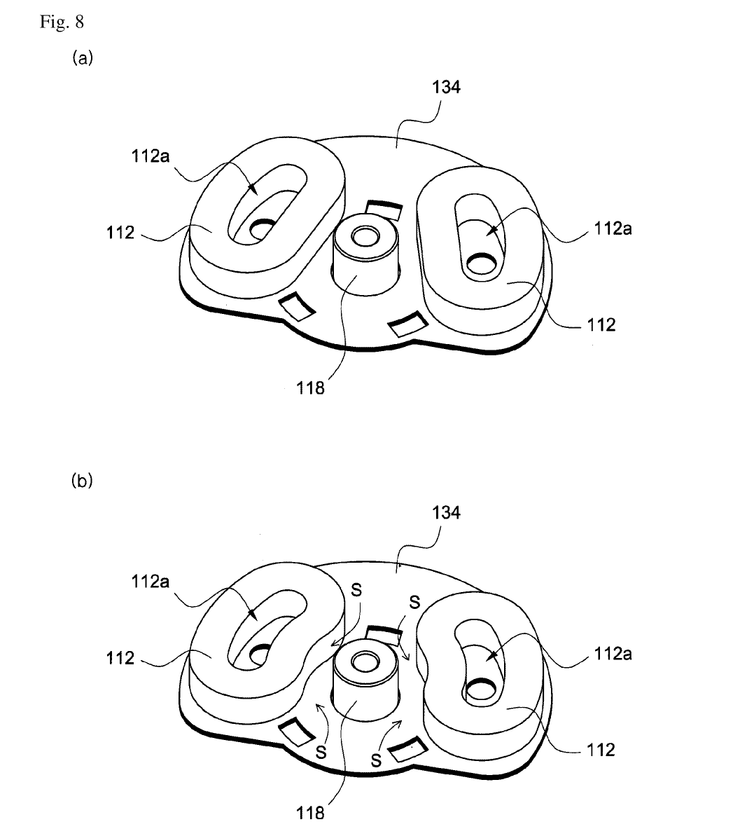

In performing the resin injection molding for integrally forming the elements of the rotor 110 into the single body, it is necessary to take measures so as to prevent the coils 112 from being deformed by the resin injection molding pressure. FIG. 8A illustrates a state of the rotor 110 before the resin injection molding (in this state, the vibrator 114 is removed for helping the understanding). When the resin is injection molded in lower and upper parts of the coils 112 in a state where the hollow cores 112a of the coil 112 are filled with nothing as illustrated in FIG. 8B (‘s’ in FIG. 8B refers to a direction of the injection of the resin injection molding body), the central parts of the coils 112 are pushed and recessed by the injection molding pressure of the resin. The coils 112 adhered to the wiring board 134 can receive the impact by the deformation of the coils, so that it may generate the disconnection error of the coils 112. Even when the degree of the coil deformation by the injection molding pressure is low, so that the disconnection is not generated, there is a possibility in that the coils 112 progressively develop the disconnection error over the course of using the vibration motor for a long time.

In order to prevent the disconnection error of the coils 112, the present invention employs a scheme in which the resin injection molding body 116 is filled in the hollow cores 112a of the coils 112, as well as the outside of the coils 112. In order to obtain the large vibration force, it is necessary to consider the fact that it is advantageous to make the vibrator 114 have the area as large as possible. In this regard, it is preferred to design the vibrator 114 so that the angle of the circular arc of the vibrator 114 covers one half or more of the upper surfaces of the coils 112 within a range of 180° based on the rotation center of the rotor 110. Such a design can generate the higher vibration force. However, in determining a size of the vibrator 114, it is also necessary to consider the forming of openings for injecting the resin injection molding body to the hollow cores 112 of the coils 112. Therefore, it is preferred that the vibrator 114 has a size proper for covering most of the hollow cores 112a of the coils 112 while leaving a part of the hollow cores 112a of the coils uncovered.

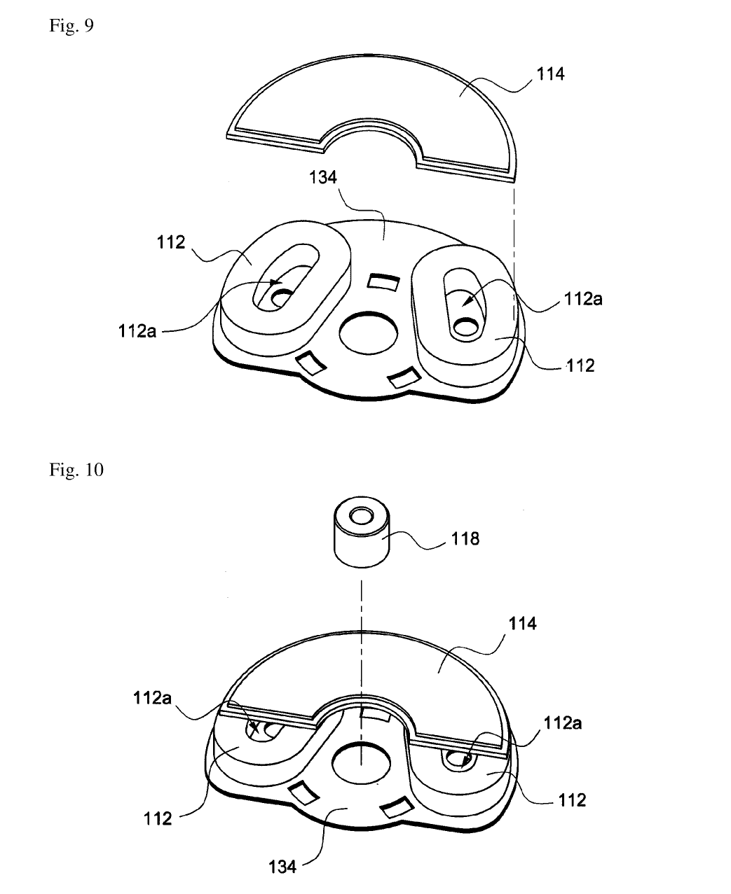

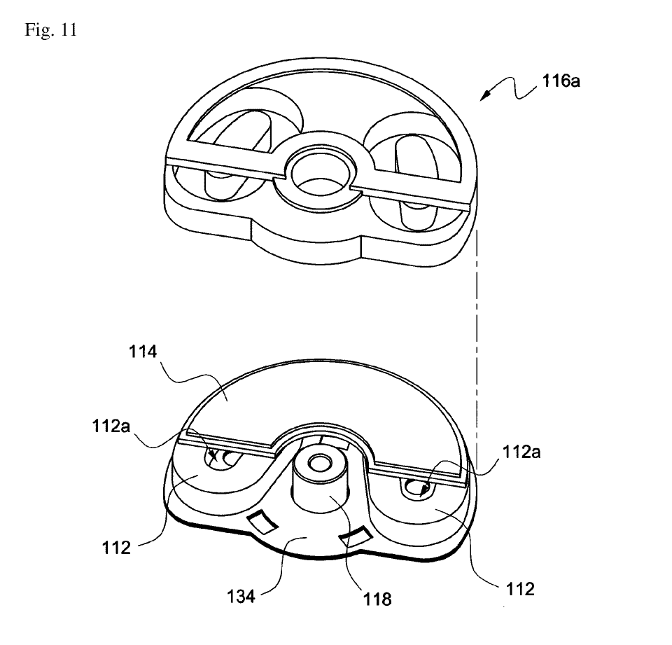

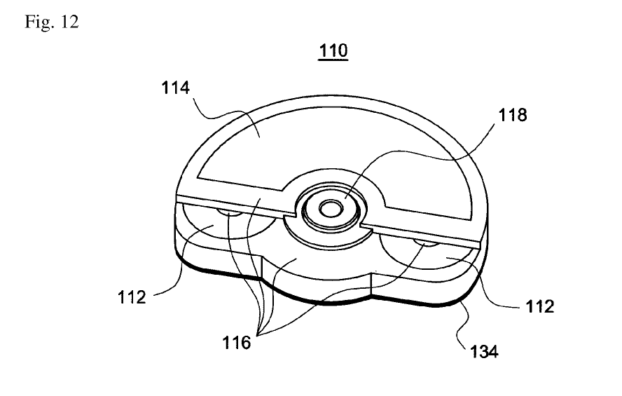

FIGS. 9 to 12 illustrate a process of the resin injection molding for the rotor 110. The two coils 112 are symmetrically disposed to each other in left and right sides on the wiring board 134 and fixed to the wiring board 134 (referring to FIG. 9), the vibrator 114 is adhered to the upper surfaces of the coils 112 (referring to FIG. 10), and the bearing 118 is positioned at the rotation center (referring to FIG. 11). The vibrator 114 does not cover the entirety of the hollow cores 112a of the coils 112, but leaves the parts of the hollow cores 112a of the coils 112 in an open state. The rotor assembled body is inserted in an injection mold 116a and the resin is injection molded. The resin injection molding body is injected to the insides of the hollow cores 112a of the coils 112 through the openings, as well as the outsides of the coils 112. Therefore, the rotor 110 integrally formed in the single body is completed (referring to FIG. 12).

In the resin injection molding according to the above process, the resin is injected to the insides of the hollow cores 112a through the opened parts of the hollow cores 112 of the coils 112, as well as the outsides of the coils 112, so that the injection molding pressure applied to the outside and the inside of the coils 112 is uniform. Therefore, it is possible to minimize the deformation (shown in FIG. 8B) of the coils 112 caused by the injection molding pressure, thereby preventing the disconnection error of the coils 112.

The bearing 118 is positioned at the rotation center of the rotor 110 and the open hole in the shaft direction is formed in the inside of the bearing 118, so that the rotation shaft 106 extends through and is assembled with the bearing 118 through the open hole. A permanent magnet 140 shaped like a ring is disposed in the lower part of the rotor 110. An N-pole and an S-pole are alternately disposed in the permanent magnet 140. A flexible printed circuit 132 for transferring a signal is disposed between the bottom of the lower case 104 and the lower surface of the permanent magnet 140. The flexible printed circuit 132 is connected with a brush 130. The permanent magnet 140 and the rotor 110 maintain a uniform clearance, and the brush 130 is in contact with the commutator 122 of the rotor 110. Here, the flexible printed circuit 132 protrudes from a lateral side of the cases 102 and 104 and is connected to a lead wire or a specific power supply terminal. A driving power supplied from the outside is supplied to the coils 112 via the flexible printed circuit 132 and the brush 130 through the commutator 122 formed at the wiring board 134.

The commutator 122 is installed at an outer circumferential surface of the bearing 118 in the inside of the wiring board 134, to be connected with the coils 112. In order to prevent the generation of a flame between the brush 130 and the commutator 122, the pattern resistor 124 capable of minimizing the wearing of the commutator 122 and the brush 130 is installed on the wiring board 134.

A noise prevention film 108 is positioned at a recess between the upper part of the rotation shaft 106 and the center of the upper case 102, so that the noise generated by the vibration in rotation of the rotor 110 is prevented from being released to the outside of the cases 102 and 104. A stopper 136 is installed in the lower part of the rotation shaft 106, so that the rotor 110 can freely rotate in a predetermined space.

The bearing 118 further includes grooves (a), which are fastening parts, on the outer circumferential surface of the bearing 118. The bearing 118 is more firmly assembled with the resin injection molding body 116 of the rotor 110 through the grooves (a). Further, the vibrator 114 includes a stepped portion (b) along the edge circumference on the upper surface of the vibrator 114 so that the vibrator 114 is firmly integrated with the resin injection molding body 116 of the rotor 110, and the stepped portion (b) functions as a shape assembling part. As described above, the bearing 118 and the vibrator 114 come to have the increased strength for assembling with the resin injection molding body 116 of the rotor 110 through the grooves (a) formed at the bearing 118 and the stepped portion (b) formed at the vibrator 114.

Based on a result of checking a characteristic of the vibration motor 100 according to the change of the entire thickness (height) of the vibrator 114 by the inventor, it is preferred that an entire thickness L1 of the vibrator 114 fixed to the upper surfaces of the coils 112 is not larger than an entire thickness L2 of the coil 112. When the entire thickness L1 of the vibrator 114 is larger than the entire thickness L2 of the coil 112, a load to the rotor 110 increases during the rotation of the rotor 110, so that the heat of the coil 112 is severely generated and the durability of the coil 112 is reduced. Further, the number of rotations of the rotor 110 and the vibration quantity may decrease.

Further, it is preferred that a height h1 of the resin injection molding body 116 at an opposite side (a rear side of the coils 112) of the position of the vibrator 114 based on the rotation shaft 106 is equal to or lower than a height h2 of the coil 112. Such a height can maximize the eccentricity of the rotor 110 and generate the largest vibration quantity.

Meanwhile, an operation of the vibration motor 100 according to the present invention is as follows. First, as illustrated in the accompanied drawings, when the power is applied to the flexible printed circuit 132, the electric current flows on the coils 112 via the brush 130 and the commutator 122 and the wiring board 134, to form the magnetic fields in the coils 112. An attraction force and a repulsion force are applied between the magnetic fields of each of the coils and the magnetic field of the permanent magnet 140, and the summed force of the attraction and repulsion force applies a rotational force to the coils 112 in a predetermined direction. Therefore, the rotor 110 rotates in a single direction with respect to the rotation shaft 106.

At this time, the rotor 110 smoothly rotates by the bearing 118. Then, the rotor 110 is eccentric from the vibrator 114, so that the rotor 110 generates the vibration while rotating. The noise caused by the vibration is blocked by the noise prevention film 108 disposed on the upper end of the rotation shaft 106.

The vibrator 114 is installed on the upper surfaces of the coils 112, so that it is possible to maximize the size of the vibrator 114, and thus the generated vibration force is much stronger than that of the conventional vibration motor. It is possible to further increase the vibration quantity by making the vibrator 114 heavier through making the thickness L1 of the vibrator 114 thicker. As such, the bearing 118 and the vibrator 114 are firmly integrated with the resin injection molding body 116 of the rotor 110 by the grooves formed at the bearing 118 and the vibrator 114, so that it is possible to use the rotor 110 for a long time without being broken by the strong impact.

The vibration motor of the present invention has a structure capable of obtaining the large vibration force in comparison with the size of the vibration motor, so that it is possible to be variously used in the case where the small-sized vibration motor is required. Especially, the vibration motor of the present invention can be appropriately adopted in the small sized electronic products (e.g. a portable electronic device, such as a mobile phone) which require the further decrease of the installation space for the elements as a user alarming means.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A coin-type vibration motor, comprising:
an upper case and a lower case, which are engaged with each other to form a circular space for rotation in an inside of the cases;
a rotation shaft vertically fitted in center parts of the upper case and the lower case opposed to each other;
a rotor rotatably supported by the rotation shaft according to that a rotation center of the rotor is positioned in the rotation shaft, the rotor being integrally assembled with plural coils and a vibrator by a resin injection molding body, the rotor having an eccentric structure and having a shape of an arc or a fan, in which the plural coils generating magnetic fields and the vibrator of high specific gravity are sequentially layered on a wiring board comprising a commutator;
a permanent magnet spaced apart from the rotor while maintaining a uniform clearance and fixed to a bottom surface of the lower case under the rotor, the permanent magnet having the N-pole and the S-pole alternately disposed around a ring-type circumference;
a flexible printed circuit installed between the permanent magnet and the bottom surface of the lower case and connected to an external power source; and
a brush, which is extended so as to include one end connected to the flexible printed circuit and another end in contact with the commutator, the brush transferring electric power transferred through the flexible printed circuit from the external power source to the coils of the rotor via the commutator,
wherein when the electric power is supplied to the coils of the rotor, the rotor eccentrically rotates with respect to the rotation shaft.

2. The coin-type vibration motor as claimed in claim 1, wherein each of the plural coils is an hollow-core coil, the resin injection molding body is filled in the hollow cores of the plural coils, and the vibrator is layered on upper surfaces of the coils while covering one half or more of the upper surfaces of the plural coils, but leaving a part of the hollow cores in an open state in order to inject the resin injection molding body into the hollow core of each of the plural coils.

3. The coin-type vibration motor as claimed in claim 1, wherein the rotor further comprises a bearing, which is positioned at the rotation center of the rotor and shaped like a cylinder having an open hole in a direction of the rotation shaft in an inside of the bearing, so that the bearing is fitted in and supported by the rotation shaft,
wherein the wiring board has an assembling hole, in which the bearing can be inserted, at a position facing the rotation center on a printed circuit board having an arc shape or a fan shape, so that the wiring board is fitted in a lower part of the bearing through the assembling hole to form a lower part of the rotor; multiple commutator patterns around an outer circumferential surface of the bearing; and multiple wire patterns connected to the multiple commutator patterns, respectively, and
wherein the rotor is shaped like a coin having an arc shape or a fan shape and adopts a circle center as the rotation center.

4. The coin-type vibration motor as claimed in claim 1, wherein the lower surface of the vibrator and the upper surfaces of the plural coils are bonded by an anaerobic UV adhesive.

5. The coin-type vibration motor as claimed in claim 1, wherein the vibrator has a stepped portion (b) along an edge circumference of the upper surface of the vibrator in order to improve an assembling force between the vibrator and the resin injection molding body of the rotor.

6. The coin-type vibration motor as claimed in claim 1, wherein the vibrator has a thickness L1 equal to or smaller than an entire thickness L2 of the plural coils.

7. The coin-type vibration motor as claimed in claim 1, wherein the vibrator is a flat plate having an arc or fan shape that can cover almost all of an arcuate or fan-shaped region of the rotor, which is enclosed by a boundary line and a circular arc connected with the boundary line and is capable of surrounding a partial portion around the bearing while leaving a part of the hollow cores of the hollow-core coils uncovered.

8. The coin-type vibration motor as claimed in claim 1, wherein the vibrator is subjected to a sintering process at a high temperature with an addition of a predetermined amount of nickel to tungsten powder of high specific gravity.

9. The coin-type vibration motor as claimed in claim 1, wherein the resin injection molding body at an opposite side (a rear side of the coils) of a position of the vibrator based on the rotation shaft has a height h1 equal to or lower than a height h2 of the coil.

10. The coin-type vibration motor as claimed in claim 3, wherein the bearing has fastening parts shaped like a groove at an outer circumferential surface of the bearing so as to improve an assembling force in assembling with the resin injection molding body of the rotor.

11. A coin-type vibration motor, comprising:
a permanent magnet having an N-pole and an S-pole centering around a rotation shaft fitted in a center of an inside of a case;
a flexible printed circuit disposed between the permanent magnet and a bottom surface of the case;
a brush connected with the flexible printed circuit, the brush having an upwardly and slantingly extending shape; and
a rotor spaced apart from an upper part of the permanent magnet and rotatably supported by the rotation shaft according to that a rotation center is fitted in the rotation shaft,
wherein the rotor comprises plural coils and a vibrator, in which the plural coils are disposed on a wiring board comprising a commutator and electrically connected with the wiring board, and the vibrator of high specific gravity is layered on the plural coils, and elements of the rotor are integrally assembled with each other by a resin injection molding body, to have a shape of a coin having an arc or fan shape and be eccentric from the rotation shaft, and when the rotor rotates by an interaction between magnetic fields generated by the plural coils through an electric current supplied through the flexible printed circuit and the brush and the magnetic poles of the permanent magnet, the rotor eccentrically rotates to generate vibration.

12. The coin-type vibration motor as claimed in claim 11, wherein the rotor further comprises a bearing, which is positioned at the rotation center of the rotor and is shaped like a cylinder having an open hole in a direction of the rotation shaft in an inside of the rotor, so that the bearing is fitted in and supported by the rotation shaft.

13. The coin-type vibration motor as claimed in claim 11, wherein the rotor comprises:
a bearing positioned at the rotation center of the rotor and fitted in and supported by the rotation shaft;
a wiring board including an assembling hole, in which the bearing is inserted, at a rotation center of a circuit board disposed as a lower part of the rotor, and multiple commutator patterns and wire patterns connected to the plural commutator patterns, respectively, around an outer circumferential surface of the bearing;
plural coils symmetrically spaced apart from each other centering around the rotation shaft in a predetermined distance on the wiring board and connected to the wire patterns of the commutator, the plural coils generating magnetic fields when an electric current flows therethrough; and
a vibrator made of a material of high specific gravity, shaped like an arc or a fan extending from a circumference of the bearing to a vicinity of a circumference of the rotor, and layered on upper surfaces of the coils; and
a body formed with a resin injection molding body which is injection molded between entire elements of the rotor to make the elements be integrally assembled with each other, and makes an entire shape of the rotor have a coin-shape like an arc or a fan having a size larger than a size of the wiring board.

14. The coin-type vibration motor as claimed in claim 12, wherein the bearing has fastening parts shaped like a groove at an outer circumferential surface of the bearing so as to improve an assembling force in assembling with the resin injection molding body of the rotor.

15. The coin-type vibration motor as claimed in claim 11, wherein the vibrator has a stepped portion (b) along an edge circumference of an upper surface of the vibrator so as to improve an assembling force between the vibrator and the resin injection molding body of the rotor.

16. The coin-type vibration motor as claimed in claim 13, wherein the vibrator is a flat plate having an arc or fan shape that can cover almost all of an arcuate or fan-shaped region of the rotor, which is enclosed by a boundary line and a circular arc connected with the boundary line and is capable of surrounding a partial portion around the bearing while leaving a part of the hollow cores of the hollow-core coils uncovered.
